(19) United States
(12) Patent Application Publication
(10) Pub. No.: US 2008/0107779 A1
(43) Pub. Date: May 8, 2008

(54) PANCREPE AND METHOD OF MAKING SAME

(75) Inventor: Olivia KELVIN, Chicago, IL (US)

Correspondence Address: FOLEY & LARDNER LLP, 150 EAST GILMAN STREET, P.O. BOX 1497, MADISON, WI, 53701-1497, US

(73) Assignee: Sara Lee Corporation

(21) Appl. No.: 11/556,901

(22) Filed: Nov. 6, 2006

(51) Int. Cl. A23P 1/08; A21D 10/04; A23L 1/00

(52) U.S. Cl. 426/95; 426/552; 426/94; 426/283

(57) ABSTRACT

Pancrepe batters are described having flour, a leavening system, moisture, and an effective amount of a protein supplement to allow a pancrepe formed from cooking the batter to be folded into a shape while warm, without breaking or cracking the pancrepe, and after cooling the pancrepe maintains the folded shape. Methods for making pancrepes and filled pancrepes are also included as well as the pancrepe and filled pancrepe.

### FIELD OF THE INVENTION

Generally, the present invention is directed to bakery products. In particular, described is a pancrepe that may be shaped, contain a filling, be frozen, and be thawed without breaking or cracking.

### BACKGROUND

Pancakes and crepes are ubiquitous breakfast and desert fare. For years, such bakery products have been bathed in butter, syrup, jams, jellies, eggs, or any food someone desires to eat with a pancake or crepe. Typically, pancakes and crepes are flat in shape and the toppings are layered on the top. As a result, the product is messy to eat and utensils are required to consume these types of foods.

Pancake batters are typically made of flour, water, eggs, and a leavening system, along with other additives that one of skill in the art may variously use. Pancakes are typically made by cooking an obverse side on a griddle or pan, followed by flipping the pancake to cook the reverse side. The final pancake product has a cake-like consistency with both sides browned and is commonly known to those of skill in the art and laypersons alike. Crepes are typically made from batters that have high egg content and no leavening system, and therefore are thin and flimsy.

While recipes and methods of making such bakery type products are known, certain features have eluded those of skill in the art and layperson alike. For example, after cooking a pancake and cooling, bending the pancake leads to cracking or breaking of the pancake along the bend. On the other hand, crepes, because they are thinner, are able to bend without breaking, but are flimsy, and do not have enough substance to aid in maintaining a shape.

### SUMMARY

In one aspect, the invention relates to a product and process for producing a shaped pancake. Pancrepe batters of the invention allow for the preparation of a flexible pancake-like bakery product, herein termed a “pancrepe,” and methods of making the same. In one such embodiment, a batter is provided comprising flour, a leavening system, moisture, and an effective amount of a protein supplement to allow a pancrepe formed from cooking the batter to be folded into a shape while warn, without breaking or cracking the pancrepe, and after cooling the pancrepe maintains the folded shape. In some such batters, the effective amount of a protein supplement is from about 1.0 wt % to about 10 wt %, and the protein supplement comprises egg protein at about 1.6 wt % to about 4.0 wt %. In some pancrepe batters, the protein supplement comprises egg proteins, dairy proteins, gluten (from flour), or a mixture of any two or more thereof. Moisture may be added to the pancrepe batter from a number of sources, including but not limited to water.

In some embodiments the pancrepe is a folded pancrepe, filled with a savory filling, a sweet filling, or a mixture of any two or more thereof, and the pancrepe is folded around the filling or fillings. In other embodiments, the folded pancrepe is a frozen pancrepe. In yet other embodiments, the frozen pancrepe is capable of being thawed without breaking or cracking the pancrepe. And in other embodiments, the frozen pancrepe is capable of being microwaved or baked further without breaking or cracking the pancrepe.

In other embodiments the batter may further comprise a humectant, a fat, a hydrocolloid, an emulsifier, or mixtures of any two or more thereof. The source of moisture may be water. The fully baked product is more flexible than a typical pancake or waffle, while retaining a structural integrity.

In some batters, the leavening system comprises an acidic leavening agent and a basic leavening agent. For example, in some batters the acidic leavening agent is sodium aluminum phosphate and the basic leavening agent is sodium bicarbonate.

In other batters the flour may be present at about 15 wt % to about 40 wt %, the leavening system may be present at about 0.1 wt % to about 5 wt %, the protein supplement may be present at about 1.0 wt % to about 10 wt %, and the moisture may be present at about 35 wt % to about 65 wt %.

In another aspect, a pancrepe batter is provided comprising flour, a leavening system, moisture, and an effective amount of a protein supplement to allow a pancrepe formed from cooking the batter to be folded into a shape while cool, without breaking or cracking the pancrepe.

Methods for making pancrepes from the described pancrepe batters are also provided. For example, some methods comprise making a pancrepe of by cooking the batters of present invention, adding a filling to the pancrepe; and folding the pancrepe around the filling to form a folded pancrepe; wherein the folding of the pancrepe around the filling is capable of being completed without breaking or cracking of the pancrepe.

After cooking the pancrepe may have a specific volume of greater than 1.0 cm³/g, from about 1.5 cm³/g to about 3.0 cm³/g, from about 2.0 cm³/g to about 2.8 cm³/g, from about 2.1 cm³/g to about 2.7 Cm³/g, from about 2.2 cm³/g to about 2.6 cm³/g, from about 2.2 cm³/g to about 2.5 cm³/g, from about 2.2 cm³/g to about 2.4 cm³/g, or about 2.3 cm³/g. The thickness of the pancrepe after cooking may be greater than 0.1 inches, from about 0.15 inches to about 0.5 inches, from about 0.2 inches to about 0.4 inches, or about 0.25 inches.

In such embodiments, after baking the pancrepe, a filling is placed on the pancrepe. Such fillings may include jams, jellies, fruit, cream cheese, chocolate, peanut butter, eggs, crèmes, meats, sauces, vegetables, cheeses, other fillings, and the like, or combinations of any two or more thereof. After filling the pancrepe, the pancrepe may be folded around the filling to form a filled pancrepe, without breaking, cracking, or tearing along a fold line.

In some embodiments, the pancrepe is formed into a shape while warm or before the starch and/or protein sets. Examples of forming into a shape may include folding, rolling, placing onto a mold, and the like. As the product cools, the starch and/or protein sets, and the shape is maintained. Such shapes may be more convenient for someone to eat, rather than the typical flat, topped pancake, eaten with a fork and knife. Such shapes include a pancrepe that has a fruit filling deposited in the center and two sides of the pancake are folded to form a wedge-shaped portable product.

In other embodiments, after freezing and thawing the filled pancrepe maintains the pre-frozen shape without cracking or breaking along the fold line. The finished product can be stored either at freezing or refrigerated temperatures, and can be subsequently microwaved, baked, or thawed before being consumed.

In another embodiment, methods for preparing a pancrepe are provided and include preparing a batter, cooking the batter to form a pancrepe, adding a filling, and shaping the pancrepe around the filling to form a filled pan crepe, wherein the shaping of the pancrepe is completed without breaking or cracking of the pancrepe. In such embodiments, the filled pancrepe may be prepared for refrigeration or frozen.

### DETAILED DESCRIPTION

The present invention is described herein using several definitions, as set forth below and throughout the application.

For the purposes of this disclosure and unless otherwise specified, “a” or “an” means “one or more.”

As used herein “humectant” refers to a substance that absorbs or helps another substance retain moisture.

As used herein “hydrocolloid” refers to a material that forms a gel with water. In particular, materials that form a gel to thicken a batter.

As used herein “emulsifier” refers to materials that facilitate the mixing of fat substances and water in a batter.

“Specific volume,” as used herein refers to the number of cubic centimeters (cc or cm³) per gram of material. Specific volume is inversely proportional to the density of a material.

Unless specifically stated, wt % is based upon a total batter formulation.

A pancrepe has the flexibility of a crepe but the texture of a pancake. Pancrepes, like their pancake, and crepe cousins, are prepared from a batter. Batters of the invention comprise flour, a protein supplement, a leavening system, moisture, an effective amount of a protein supplement to allow a pancrepe formed from cooking the batter to be folded with less breaking or cracking than a pancake batter. In other embodiments, the batter further comprises a humectant, a fat, a hydrocolloid, an emulsifier, other various other ingredients known to those of skill in the art, or a mixture of any two or more thereof. Moisture may be in the form of water. Typical amounts of each ingredient that may be used in a pancrepe are listed below in Table 1.

TABLE I
Ingredient Levels for a Pancrepe

| Ingredient | Percentage (wt %) |
|---|---|
| Flour | 15–40% |
| Protein Supplements | 1.0–10% |
| Egg Proteins | 1.6–4.0% |
| Dairy Proteins | 1.0–4.0% |
| Humectants | 0–20% |
| Leavening system | 0.1–5% |
| Fat | 0–20% |
| Emulsifier | 0–5% |
| Hydrocolloids | 0–5% |
| Moisture | 35–65% |

Flour may be present in the pancrepe batter at levels from 15-40%, or at levels to sufficient to provide structure to the product. Such flours include soft wheat flour, hard wheat flour, whole wheat flour, whole white wheat flour, corn flour, rice flour, oat flour, barley flour, soy flour, high amylose flour, low amylose flour, or combinations of any two or more thereof, and the like. Flour can be treated or untreated. Such treatments include bleaching, malted flours, heat treatment, addition of oxidizing agents, maturing agents, or reducing agents, enrichment with vitamins and/or minerals, combinations of any two or more thereof, and the like. The recommended flour levels are based on a flour having a protein level of 7 to about 15 weight percent and 9 to about 11 weight percent moisture. In one embodiment, the pancrepe batter of the invention includes wheat flour.

Protein Supplements are added to provide structure, strength, and flexibility to the product. The protein supplements also aid in processing the product during the folding process. Protein supplements can also aid in achieving the desired cake-like pancrepe texture. The protein supplement level ranges from about 1.0% to about 10.0%. Protein supplements may include egg proteins, dairy proteins, and wheat proteins (gluten in flour). Examples of dairy proteins include caseinate, buttermilk, buttermilk solids, milk, nonfat dry milk, dried whole milk, instant nonfat dry milk, whey, milk protein concentrate, soy protein, and the like. In some embodiments, egg protein levels are added at levels from about 1.5% to about 4.0% and dairy proteins are added at levels from about 1.0% to about 4.0%. In one embodiment, the pancrepe batter of the invention includes a protein supplement having a combination of nonfat dry milk, egg proteins, and gluten (from flour). Other suitable protein supplements can include amino acids such as cystine, serine, histidine, aspartic acid, lysine, arginine, glutamic acid, asparagine, glutamine, threonine, methionine, proline, tryptophan, turicine, glycine, leucine, alanine, isoleucine, valine, and phentolamine. Other such protein supplements may include actin, collagen, keratin, carboxypeptidase, trypsin, fibroin, sclerolin, myosin, and the like.

One of the ingredients which provides for flexibility of the product is the high level of eggs in the formula. In the presence of heat, the eggs provide a structure to allow for product flexibility. Although there is protein in the flour (gluten), and milk proteins in the non-fat dry milk, they do not have the same structure forming properties as the egg protein. While the total protein level present in pancakes and pancrepes is very similar (about 6 wt %), the egg protein level varies significantly. For example, liquid whole egg levels in pancakes range from about 8 wt % to about 12 wt % and in crepes the amount ranges from about 15 wt % to about 30 wt %. Since liquid whole eggs contain approximately 12.58 wt % egg protein, the egg protein levels in pancakes range from 1 wt % to 1.5 wt % and in crepes the amount ranges from about 1.8 wt % to about 3.75 wt %. For the pancrepe batter exemplified in Table II, the liquid whole egg level is about 18 wt % which corresponds to about 2.26 wt % egg proteins. Pancrepe batters embodied herein contain an egg protein level from about 1.6 wt % to about 4.0 wt %. The result is a pancrepe where the level of eggs was increased, relative to that of a pancake, to compensate for the increased fragility associated with an increase in the specific volume and an increase in product thickness. The specific volume of conventional pancakes generally ranges from about 2.25 cm³/g to 3.0 cm³/g and the specific volume of conventional crepes generally ranges from about 0.7 cm³/g to 1.0 cm³/g. Preferably, the pancrepes made from the pancrepe batters of the invention have a specific volume greater than about 1.0 cm³/g. For example, pancrepes may have a specific volume of from about 1.5 cm³/g to about 3.0 cm³/g, from about 2.0 cm³/g to about 2.8 cm³/g, from about 2.1 cm³/g to about 2.7 cm³/g, from about 2.2 cm³/g to about 2.6 cm³/g, from about 2.2 cm³/g to about 2.5 cm³/g, from about 2.2 cm³/g to about 2.4 cm³/g, or about 2.3 cm³/g. In other words, the pancrepe has a specific volume similar to that of a pancake, with the flexibility of a crepe. In addition, the thickness of conventional pancakes generally ranges from about 0.3 inches to about 0.5 inches and the thickness of conventional crepes generally ranges from about 0.05 inches to about 0.1 inches. Pancrepes embodied herein generally have a thickness greater than 0.1 inches, from about 0.15 inches to about 0.5 inches, from about 0.2 inches to about 0.4 inches, or about 0.25 inches.

Humectants are added to the pancrepe batter of the invention to provide sweetness, provide browning during the cooking process, tenderize the product, and to retain moisture in order to prevent product breakage. Humectants may be sugar-based, non-sugar-based, or a combination of any two or more thereof. Sugar-based humectants include sucrose, glucose, fructose, dextrose, corn syrup, corn syrup solids, invert syrup, high fructose corn syrup, maltose, honey, sorbose, mannose, maltose, lactose, galactose, combinations of any two or more thereof, and the like. Non-sugar-based humectants include glycerin, xylitol, propylene glycol, hydrogenated starch hydrolysates, sugar ester, dextrin, maltitol, mannitol, sorbitol, glycerol, combinations of any two or more thereof, and the like. If added to the pancrepe batter, humectants are preferably added up to about 20% weight. In one embodiment, the pancrepe batter of the invention includes sucrose (sugar) as the humectant.

Pancrepe batters of the invention include a leavening system to aerate the product in order to increase a specific volume of the product and to provide the desired cake-like texture. The leavening system is included at levels from about 0.1% weight to about 5% weight. The leavening system may consist of an acidic leavening agent and a basic leavening agent which react in the presence of water to produce carbon dioxide. The leavening system can be either single acting or double acting. Single acting leavening systems generally consist of heat activated acidic leavening agents. In this case, the acidic and basic leavening agents do not react until they are exposed to heat. On the other hand, double acting leavening systems consist of both a heat activated leavening acid and a leavening acid that instantly reacts with the basic leavening agent in the presence of water. A portion or all of either the basic or acidic leavening agents may be encapsulated.

Basic leavening agents that are useful in batters used to make the embodied pancrepes include sodium bicarbonate (baking soda), ammonium carbonate, potassium bicarbonate, ammonium bicarbonate, combinations of any two or more thereof, and the like. In one embodiment, embodied pancrepe batters include sodium bicarbonate (baking soda) as the basic leavening agent.

Acidic leavening agents that are useful in batters used to make the embodied pancrepes include sodium aluminum phosphate, sodium acid pyrophosphate, monocalcium phosphate monohydrate, monocalcium phosphate anhydrous, dicalcium phosphate dihydrate, dicalcium phosphate, glucono-deltalactone, sodium aluminum sulfate, potatssium hydrogen tartrate, combinations of any two or more thereof, and the like. In one embodiment, the pancrepe batter includes sodium aluminum phosphate as the acidic leavening agent.

Fats are added to provide a soft and tender texture and to improve product flexibility. Forms of fats that are useful in batters used to make the embodied pancrepes include liquid oils, shortenings, shortening chips, margarines, combinations of any two or more thereof, and the like. The source of fat can be either animal, vegetable, or synthetic. Sources of fat may include soybean oil, coconut oil, palm kernel oil, cottonseed oil, peanut oil, olive oil, lard, butter, sucrose polyesters, sunflower seed oil, sesame seed oil, corn oil, safflower oil, poppy seed oil, canola (rapeseed) oil, babassue oil, combinations of any two or more thereof, and the like. If added to the pancrepe batter, fats are preferably added up to about 20% weight. In one embodiment, the pancrepe batter includes liquid soybean oil as the fat.

Emulsifiers are optionally added to the batters to enhance fat and water mixing, tenderize the product, improve product consistency, improve product flexibility, and improve batter stability. Emulsifiers that are useful in batters used to make the embodied pancrepes include lecithin, mono- and diglycerides of fatty acids, diacetyl-tartrate ester of monoglyceride, sodium stearoyl lactylate, sodium stearoyl fumarate, propylene glycol monoester, polysorbate 60, propylene glycol esters of fatty acids, succinyl monoglyceride, acetylated monoglyceride, sorbitan monostearate, sucrose esters, combinations of any two or more thereof, and the like. If added to the pancrepe batter, emulsifiers are added up to about 5% weight. In one embodiment, the pancrepe batter includes soy lecithin as the emulsifier.

Hydrocolloids can be optionally added to the batters to improve product flexibility, improve texture, and achieve desired batter viscosity. If added to the pancrepe batter, hydrocolloids are added up to about 5% weight. Hydrocolloids that are useful in batters used to make the embodied pancrepes include xanthan gum, guar gum, gellan gum, locust bean gum, tara gum, gum arabic, gum karaya, sodium alginate, carrageenan, konjac gum, tragacanth, agar, cellulose gum, microcrystalline cellulose, methylcellulose, pullulan, hydroxypropylcellulose, pectin, combinations of any two or more thereof, and the like. In one embodiment, the pancrepe batter includes xanthan gum as the hydrocolloid.

Moisture is added to the pancrepe batter at levels from about 35% to about 65% of total weight. Sources of moisture include added water or water-containing ingredients such as eggs, buttermilk, milk, and the like.

The pancrepe batters of the invention can also include additional ingredients such as starches, nutritional enhancements, flavoring agents, coloring agents, inclusions/particulates, shelf life stabilizing ingredients, combinations of any two or more thereof, and the like.

Starches may be added to the product to alter the viscosity of the raw batter or to adjust the volume and texture of the baked pancrepe. Examples of starches include corn starch, wheat starch, potato starch, barley starch, rice starch, tapioca starch, oat starch, sago starch, combinations of any two or more thereof, and the like. The starch can also be modified or pregelatinized. If present, starches are included up to about 5% weight.

Nutritional enhancing ingredients that may be added include vitamins, minerals, fibers, whole grains, proteins, combinations of any two or more thereof, and the like.

Flavoring agents that may be added include salt, spices, seasonings, artificial high intensity sweeteners such as sucralose, flavors, cocoa, cheese powders, ground vegetable powders, combinations of any two or more thereof, and the like.

Inclusions/particulates can also be added to the pancrepe batter. Examples include chocolate bits, flavored chips/bits, fruits, nuts, butterscotch bits, maple bits, cinnamon bits, peanut butter chips, vegetables, combinations of any two or more thereof, and the like.

Shelf life stabilizing ingredients can also be optionally added to the pancrepe batter. Such ingredients include antioxidants, pH regulators, chelating agents, antimicrobial agents, and the like. Examples of antioxidants include butylated hydroxyl anisole, butylated hydroxyl toluene, tertiary butyl hydroquinine, and the like. Examples of pH regulators include citric acid, calcium acetate, sorbic acid, and the like. Example of a chelating agent is ethylene diaminetetraacetate (EDTA), and the like. Examples of antimicrobial agents include potassium sorbate, sorbic acid and its derivatives, propionic acid and its derivatives, sodium diacetate, vinegar, monocalcium phosphate, lactic acid, citric acid, and the like.

Batters embodied herein may be cooked or baked on one side using a typical griddle or pan, and then flipped over to cook or bake the other side. The batters may also be cooked simultaneously on both sides without being flipped. Once a pancrepe is cooked, a filling may then be deposited on the surface of the pancrepe, and while still warm, the sides of the pancrepe may be folded over the filling to form a filled pancrepe. For example, a filling of egg and vegetables in a predetermined shape may be placed on the pancrepe and the edges of the pancrepe folded over the filling to form the filled pancrepe.

The fillings may be selected from a wide range of fillings known to the consumers of pancakes or crepes. In one embodiment, the filling is a savory filling. In another such embodiment the filling is a sweet filling. For example, savory fillings may include those made from cheese, meat, eggs, sauces, vegetables, butter, or a mixture of any two or more thereof, and the like. Sweet fillings may include those such as fruits, jams, preserves, flavored syrups, jellies, crèmes, maple syrup, cream cheese, chocolate, peanut butter, or a mixture of any two or more thereof. One or more savory fillings may also be combined with one or more sweet fillings.

Fillings may be deposited on the pancrepe as the filling itself, or as a filling puck. A filling puck will be understood to be a solid form of the filling, in some embodiments a frozen form of the filling, where the shape of the filling puck will determine the final shape of the folded filled pancrepe. The filling puck may take any shape. For example, the filling puck may be a fruit and crème filling that is first molded and frozen into a shape, the frozen filling is then placed on the warm pancrepe, the pancrepe folded, at least partially around the filling, and the filled pancrepe frozen for packaging. In another example, the filling puck is a savory puck consisting of meat, egg, vegetables, and cheese, that may be placed, either frozen or unfrozen, on the pancrepe. The savory pucks can be formed using several different methods. One non-limiting method is the use of a pressurized mold where the savory filling is deposited or pumped into a mold and the filling is pressurized between two plates within the mold to form the puck. Another non-limiting method of producing a savory filling is accomplished by mixing the savory particulates in liquid eggs. The egg mixture is then deposited into a mold and baked. The result is a baked savory egg puck.

One of the salient features of the pancrepe, is the unique combination of the pancrepe having the texture of a pancake and the flexibility of a crepe, such that when the edges of the pancrepe are folded over a filling, as above, the pancrepe does not break or crack along that line of folding. The pancrepe may be folded while still warm, or it may be folded when cool, without breaking or cracking. As used herein, the term warm refers to the pancrepe being recently cooked or baked and has not yet cooled to room temperature or below after the cooking or baking process. As used herein, the term cool refers to the pancrepe at room temperature or below after the cooking or baking process. If the pancrepe is folded while warm, prior to the setting of the protein and starch present in the flour, the pancrepe will hold the folded shape when cool. In some embodiments, the pancrepe maintains the shape after freezing and thawing, without breaking or cracking. In some embodiments, the pancrepe, whether filled or not, is capable of being folded without breaking or cracking of the pancrepe and such capability to not break or crack may also be retained during and after freezing, and/or during and after thawing, and/or during and after microwaving or additional baking. The pancrepe maintains a flexibility at non-freezing temperatures. For example, the pancrepe may be folded when warm or cool, without breaking or cracking. If the pancrepe is folded while cool, the pancrepe may not maintain the folded shape. However, a separate holder may be introduced to aid in maintaining the shape, or an edible adhesive such as gluten or a sauce may be added to overlapping portions of the folded pancrepe, thus holding the folded pancrepe in the folded shape.

While individual pancrepes may be cooked or baked, individual pancrepe production on a griddle or pan is not feasible for large scale manufacturing processes. Therefore, provided are several non-limiting methods of preparing the pancrepe for large scale production. All methods involve a mixing stage where the batter is first mixed followed by a cooking stage. The cooking stage involves the transfer of heat by either conduction or convection or a combination of both. Heat generating, or cooking, equipment can either be gas or electric powered and either direct fired or indirect fired. Such non-limiting examples include a tunnel oven, a griddle line, and a BERIEF Quantum Belt Grill, available from ScanAmCorp (Kansas City, Mo.).

The tunnel oven involves depositing a predetermined amount of batter onto a hot, steel belt. The product is then advanced into the first tunnel oven. The tunnel oven is an enclosed chamber with heat generating units located above and below the steel belt that can be adjusted to regulate the temperature within the oven. The transfer of heat to the pancrepe batter involves conductive heat where the batter is in direct contact with the hot belt and convective heat where the batter is in direct contact with the hot air within the tunnel oven. The partially baked pancrepe exits the first tunnel oven, is flipped, and then enters a second tunnel oven. The pan crepe exits the second tunnel oven when it has been completely baked.

The griddle line involves depositing a predetermined amount of batter onto a belt containing hot steel plates. The product is cooked primarily with conductive heat where the batter is in direct contact with the hot steel plates. There is very little convective heat transfer because the belt does not enter an enclosed heated chamber. The pancrepe is then flipped so that the other side of the pancrepe can be cooked.

The Berief Oven involves depositing a predetermined amount of batter onto a hot, lower belt of a belt oven and the pancrepe is advanced into the belt oven to cook. Heating elements on the top and bottom belts of the belt oven are positioned to evenly cook both sides of the pancrepe. With this method, the pancrepe does not need to be flipped as the pancrepe is cooked on both sides simultaneously.

After the cooking stage, a filling is then deposited onto a warm pancrepe. The filling can be deposited in a loose format as the filling itself either manually or with depositing equipment. Or, the filling can be deposited as a puck either manually, or by pick and place robotic equipment, or by on-line puck forming equipment such as Nutec 725 C-Frame Filling & Portion Depositor available from Nutec Manufacturing, New Lenox, Ill. The edges of the pancrepe are then folded over the filling puck. Optionally, edible adhesive, such as a gluten product or a sauce, may be applied to one edge of the pancrepe such that when the pancrepe is folded, an edge of the pancrepe will overlie the gluten or sauce application, thereby aiding in holding the pancrepe in the folded conformation. The folded, filled pancrepe may also be placed into a holder which aids in maintaining the folded shape of the pancrepe and provides a convenient holder for the consumer.

Other embodied methods may include one or more of freezing or blast freezing the filled pancrepe, and packing in a holder, without breaking or cracking of the pancrepe. Additionally, embodied methods include thawing the filled pancrepe, wherein the thawing is capable of being completed without breaking or cracking of the pancrepe, and optionally microwaving or further baking the filled pancrepe, wherein the microwaving or further baking is capable of being completed without breaking or cracking of the pancrepe.

One skilled in the art will readily realize that all ranges and ratios discussed can and do necessarily also describe all subranges and subratios therein for all purposes and that all such subranges and subratios also form part and parcel of this invention. Any listed range or ratio can be easily recognized as sufficiently describing and enabling the same range or ratio being broken down into at least equal halves, thirds, quarters, fifths, tenths, etc. As a non-limiting example, each range or ratio discussed herein can be readily broken down into a lower third, middle third and upper third, etc.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

### EXAMPLES

As a non-limiting example, Table II lists the ingredients for one exemplary pancrepe batter

TABLE II
Exemplary pancrepe batter formulation:

| Ingredient | Percentage (wt %) |
|---|---|
| Wheat Flour | 24.86 |
| Sodium Bicarbonate | 0.55 |
| Sodium Aluminum Phosphate | 0.55 |
| Non-fat Dry Milk (31.16% milk | 5.36 |
| proteins) | |
| Sugar (sucrose) | 7.31 |
| Water | 35.30 |
| Liquid Whole Egg (12.58% egg | 18.99 |
| protein solids) | |
| Salt | 0.55 |
| Vanilla Flavor | 1.10 |
| Soybean Oil | 5.03 |
| Xanthan Gum | 0.30 |
| Soy Lecithin | 0.1 |

While one, non-limiting embodiment of the batter has been illustrated and described it should be understood that changes and modifications can be made therein in accordance with ordinary skill in the art without departing from the invention in its broader aspects as defined in the following claims.

What is claimed is:

1. A pancrepe batter comprising:
flour, a leavening system, moisture, and
an effective amount of a protein supplement to allow a pancrepe formed from cooking the batter to be folded into a shape while warm, without breaking or cracking the pancrepe, and after cooling the pancrepe maintains the folded shape.

2. The pancrepe batter of claim 1, wherein the pancrepe is a folded pancrepe, filled with a savory filling, a sweet filling, or a mixture of any two or more thereof, and the pancrepe is folded around the filling or fillings.

3. The pancrepe batter of claim 2, wherein the folded pancrepe is a frozen pancrepe.

4. The pancrepe batter of claim 3, wherein the frozen pancrepe is capable of being thawed without breaking or cracking the pancrepe.

5. The pancrepe batter of claim 3, wherein the frozen pancrepe is capable of being microwaved or baked further without breaking or cracking the pancrepe.

6. The pancrepe batter of claim 1, further comprising a humectant, a fat, a hydrocolloid, an emulsifier, or a mixture of any two or more thereof.

7. The pancrepe batter of claim 1, the leavening system comprises an acidic leavening agent and a basic leavening agent.

8. The pancrepe batter of claim 7, wherein the acidic leavening agent is sodium aluminum phosphate and the basic leavening agent is sodium bicarbonate.

9. The batter of claim 1, wherein the protein supplement comprises egg proteins, dairy proteins, gluten, or a mixture of any two or more thereof.

10. The batter of claim 1, wherein the effective amount of a protein supplement is from about 1.0 wt % to about 10 wt % and the protein supplement comprises eggs at about 1.6 wt % to about 4.0 wt %.

11. The pancrepe batter of claim 1, wherein the flour is present at about 15 wt % to about 40 wt %, the leavening system is present at about 0.1 wt % to about 5 wt %, the protein supplement is present at about 1.0 wt % to about 10 wt %, and the moisture is present at about 35 wt % to about 65 wt %.

12. A pancrepe batter comprising:
flour, a leavening system, moisture, and
an effective amount of a protein supplement to allow a pancrepe formed from cooking the batter to be folded into a shape while cool, without breaking or cracking the pancrepe.

13. A method of making the pancrepe of claim 1 comprising:
cooking the batter to form the pancrepe;
adding a filling to the pancrepe; and
folding the pancrepe around the filling to form a folded pancrepe;
wherein the folding of the pancrepe around the filling is completed without breaking or cracking of the pancrepe.

14. The method of claim 13, wherein the method further comprises freezing the folded pancrepe to form a frozen pancrepe, wherein the freezing step is completed without breaking or cracking of the pancrepe.

15. The method of claim 14, wherein the method further comprises thawing the frozen pancrepe, wherein the thawing is completed without breaking or cracking of the pancrepe.

16. The method of claim 15, further comprising microwaving or further baking the thawed pancrepe, wherein the microwaving or further baking is completed without breaking or cracking of the pancrepe.

17. The method of claim 14, further comprising microwaving or further baking the frozen pancrepe, wherein the microwaving or further baking is completed without breaking or cracking of the pancrepe.

18. The method of claim 13, wherein the pancrepe has a specific volume of greater than 1.0 cm³/g, from about 1.5 cm³/g to about 3.0 cm³/g, from about 2.0 cm³/g to about 2.8 cm³/g, from about 2.1 cm³/g to about 2.7 cm³/g, from about 2.2 cm³/g to about 2.6 cm³/g, from about 2.2 cm³/g to about 2.5 cm³/g, from about 2.2 cm³/g to about 2.4 cm³/g, or about 2.3 cm³/g.

19. The method of claim 13, wherein the pancrepe has a thickness greater than 0.1 inches, from about 0.15 inches to about 0.5 inches, from about 0.2 inches to about 0.4 inches, or about 0.25 inches.

20. The pancrepe prepared by the method of claim 13.

21. The folded pancrepe prepared by the method of claim 13
